(19) United States
(12) Patent Application Publication
(10) Pub. No.: US 2018/0340638 A1
(43) Pub. Date: Nov. 29, 2018

(54) CLAMPS FOR FLUID CONDUITS

(71) Applicant: Edwards Vacuum LLC, Sanborn, NY (US)

(72) Inventor: Jacob Goeke, Hillsboro, OR (US)

(21) Appl. No.: 15/605,352

(22) Filed: May 25, 2017

(51) Int. Cl. F16L 23/036; F16L 23/00; B25B 7/02

(52) U.S. Cl. CPC F16L 23/036; B25B 7/02; F16L 23/003

(57) ABSTRACT

In the field of air handling, or indeed any type of fluid handling, there is provided clamp, for holding first and second fluid conduits in fluid-tight engagement with one another via respective flanges thereof. The clamp comprises first and second clamp body portions that define corresponding first and second mutually opposed flange engagement formations. The first clamp body portion is slidably received within the second clamp body portion to restrain linearly movement of the first and second flange engagement formations towards and away from one another. The first and second flange engagement formations are resiliently biased towards one another.

### TECHNICAL FIELD OF THE INVENTION

This invention relates to a clamp for holding first and second fluid conduits in fluid-tight engagement with one another via respective flanges thereof, a fluid conduit assembly comprising first and second fluid conduits held in fluid-tight engagement with one another by a said clamp, and to a method of holding first and second fluid conduits in fluid-tight engagement with one another using such a clamp.

### BACKGROUND OF THE INVENTION

In the field of air handling, or indeed any type of fluid handling, it is very often necessary to secure first and second fluid conduits in fluid-tight engagement with one another. At present, attaching clamping mechanisms for vacuum systems, such as claw clamps or bolts, require the use of multiple tools and are difficult to consistently secure with equal force circumferentially around the flange faces of the two conduits being held and secured in fluid-tight engagement. The present invention overcomes these issues by providing a substantially consistent securing force for each clamping mechanism and only requiring a single tool to hold and secure the clamps to the flange faces of the two conduits.

### SUMMARY OF THE INVENTION

According to a first aspect of the invention there is provided a clamp, for holding first and second fluid conduits in fluid-tight engagement with one another via respective flanges thereof, comprising first and second clamp body portions defining corresponding first and second mutually opposed flange engagement formations, the first clamp body portion being slidably received within the second clamp body portion to restrain linearly movement of the first and second flange engagement formations towards and away from one another, the first and second flange engagement formations being resiliently biased towards one another.

Restraining linearly movement of the first and second flange engagement formations towards and away from one another helps to maintain the mutually opposed configuration of the first and second flange engagement formations throughout their range of movement relative to one another.

Meanwhile, resiliently biasing the first and second flange engagement formations towards one another assists, in use, in securing respective flanges together without the need otherwise to manually drive the first and second flange engagement formations towards one another, e.g. using a mechanical fastener such as a nut and bolt, which is time-consuming to achieve. As a consequence, utilisation of the clamp of the invention allows for the speedy and ready securing of first and second fluid conduits in fluid-tight engagement with one another via the respective flanges thereof.

Preferably the first clamp body portion includes an actuator portion which extends through and beyond the second clamp body portion, the actuator portion terminating at a distal end and movement of the distal end towards the second clamp body portion acting against the resilient bias to move the first and second flange engagement formations away from one another.

The inclusion of an actuator portion assists an operative in moving the first and second flange engagement formations away from one another, e.g. into an open position, and facilitates, in use, engagement of the said flange engagement formations with respective flanges of first and second fluid conduits, prior to thereafter releasing the actuator portion and allowing the resilient bias to move the first and second flange engagement portions towards one another, e.g. into a closed position, to secure the said flanges together.

The distal end of the actuator portion may define an enlarged engagement head.

The inclusion of such an enlarged engagement head assists an operative in applying a sufficient force to the actuator portion to temporarily overcome the resilient bias to move the distal end thereof towards the second clamp body portion, and thereby move the first and second flange engagement formations away from one another into an open position.

In addition, an enlarged engagement head desirably prevents separation of the first and second clamp body portions from one another.

Optionally the distal end of the actuator portion defines an enlarged engagement head and the enlarged engagement head retains a biasing member between the distal end of the actuator portion and the second clamp body portion, the biasing member urging the distal end away from the second clamp body portion.

Retaining a biasing member in the aforementioned manner conveniently provides the required resilient biasing of the first and second flange engagement formations towards one another in a compact and robust manner.

In a preferred embodiment of the invention the second clamp body portion includes a retention formation configured to retain a first jaw of a plier tool and thereby facilitate the application of a force by a second jaw of the plier tool to the distal end of the actuator portion.

Including a retention formation which allows the use of a plier tool, i.e. a pair of pliers, permits the application of a large force to the distal end of the actuator portion, and as a consequence allows the provision of a large biasing force to urge the first and second flange engagement formations towards one another (but which nonetheless can still be overcome by the plier tool) so as to help ensure satisfactory fluid-tight engagement of respective first and second fluid conduits acted upon by the clamp.

Preferably the second clamp body portion includes a retention formation configured to retain a first jaw of a plier tool and thereby facilitate the application of a force by a second jaw of the plier tool to the distal end of the actuator portion and the retention formation is formed within the second clamp body portion.

Arranging the retention formation in such a manner helps to avoid damage to the retention formation during use of the clamp, while also helping to ensure it is sufficiently strong to allow the application of a large force by the plier tool.

The second clamp body portion may include a retention formation configured to retain a first jaw of a plier tool and thereby facilitate the application of a force by a second jaw of the plier tool to the distal end of the actuator portion and the retention formation may extend beyond the second clamp body portion.

Configuring the retention formation in the foregoing manner desirably facilitates the use of a range of different plier tools to actuate the clamp of the invention.

In another preferred embodiment of the invention the second clamp body portion includes a retention formation configured to retain a first jaw of a plier tool and thereby facilitate the application of a force by a second jaw of the plier tool to the distal end of the actuator portion, the retention formation extends beyond the second clamp body portion, and the retention formation includes a rebate formation.

Providing a rebate formation allows the first jaw of a plier tool to, in use, lodge behind the rebate formation so as to permit the required application of a force by a second jaw of the plier tool to the distal end of the actuator portion.

According to a second aspect of the invention there is provided fluid conduit assembly comprising first and second fluid conduits, each of which fluid conduit has a respective flange, the said respective flanges being secured together by a clamp as described hereinabove so as to hold the first and second fluid conduits in fluid-tight engagement with one another.

Such a fluid conduit assembly shares the benefits of speedy and ready securing of first and second fluid conduits in fluid-tight engagement with one another during installation of the said assembly, as provided for by the clamp of the invention.

In addition, the use of a clamp as described hereinabove with first and second flange engagement formations that are resiliently biased towards one another, permits the selective separation of the first and second fluid conduits from one another under certain operating conditions, e.g. when a pressure within the conduits gives rise to a separation force that is greater than the resilient bias holding the conduits in fluid-tight engagement with one another. In this way the fluid conduit assembly of the invention can act to relieve an excess pressure within the conduits, rather than one or other of the conduits rupturing. Furthermore, the pressure level at which such relief is initiated can be altered by tailoring the degree of resilient bias provided.

According to a third aspect of the invention there is provided a method of holding first and second fluid conduits in fluid-tight engagement with one another via respective flanges thereof comprising the steps of:

(a) arranging the first and second fluid conduits in engagement with one another;

(b) utilising a plier tool to move first and second flange engagement formations of a clamp as described hereinabove away from another;

(c) arranging the first and second flange engagement formations in communication with the respective flanges of the first and second fluid conduits; and

(d) removing the plier tool to permit resilient biasing of the first and second flange engagement formations towards one another to secure the respective flanges of the first and second fluid conduits together and thereby hold the first and second fluid conduits in fluid-tight engagement with one another.

Use of a clamp according to the invention as described hereinabove carries with it the advantages associated with the features of the clamp, while the use of a plier tool permits the application of a large biasing force to urge the first and second flange engagement formations of the clamp towards one another, and so helps to ensure that the first and second fluid-tight conduits remain in fluid-tight engagement with one another.

### BRIEF DESCRIPTION OF THE DRAWINGS

In order that the present invention may be well understood, two embodiments thereof, which are given by way of example only, will now be described in more detail, with reference to the accompanying drawings, in which:

FIG. 1 shows a perspective view of a clamp according to a first embodiment of the invention;

FIG. 2(a) shows a plier tool in engagement with the clamp shown in FIG. 1;

FIG. 2(b) shows the plier tool alone;

FIG. 3 shows a fluid conduit assembly including first and second fluid conduits held in fluid-tight engagement with one another by the clamp shown in FIG. 1; and

FIG. 4 shows an isometric view of the clamp according to a second embodiment of the invention.

### DETAILED DESCRIPTION OF THE EMBODIMENTS

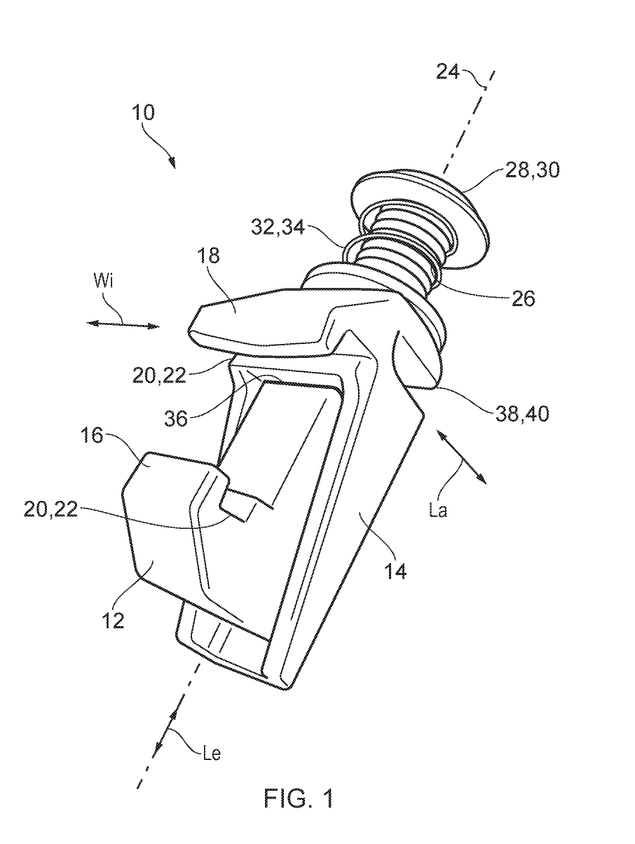

A clamp according to a first embodiment of the invention is designated generally by reference numeral 10, as shown in FIG. 1.

The first clamp 10 includes first and second clamp body portions 12, 14 that define corresponding first and second mutually opposed flange engagement formations 16, 18. In the embodiment shown, each of the first and second flange engagement formations 16, 18 includes a recess formation 20 in the form of a slot 22 which extends widthwise thereacross. In other embodiments of the invention (not shown) one or more of the recess formations may be omitted and/or they may take a different form.

The first clamp body portion 12 is slidably received within the second clamp body portion 14 in a manner that restrains movement of the first and second flange engagement formations towards and away from one another in a linear direction. More particularly, the first clamp body portion 12 has a substantially rectangular cross-sectional profile which is received within a complimentary, substantially rectangular open channel cross-sectional profile of the second clamp body portion 14. In such a way the first and second clamp body portions 12, 14 are restrained from moving in a widthwise direction Wᵢ relative to one another, as well as from rotating relative to one another about a common axis 24 extending in a lengthwise direction Lₑ relative to both the first and second clamp body portions 12, 14. Meanwhile, however, the first and second clamp body portions 12, 14 are able to move in the said lengthwise direction Lₑ relative to one another, so as to provide for the said restrained linear movement of the first and second flange engagement formations 16, 18 towards and away from one another.

The first clamp body portion 12 includes an actuator portion 26 which extends through and beyond the second clamp body portion 14. Such extension of the actuator portion 26 through the second clamp body portion 14 assists further in restraining movement of the first clamp body portion 12 relative to the second clamp body portion 14, and in particular inhibits to a degree the extent to which the first and second clamp body portions 12, 14 are able to move in a lateral direction Lₐ, which extends perpendicularly to both the aforementioned widthwise and lengthwise directions Wᵢ, Lₑ, relative to one another.

The actuator portion 26 terminates at a distal end 28 which defines an enlarged engagement head 30.

The enlarged engagement head 30 retains a biasing member 32 between the distal end 28 of the actuator portion 26 and the second clamp body 14. In the embodiment shown the biasing member 32 takes the form of a compression spring 34, although other forms of biasing member may be used.

The biasing member 32, i.e. the compression spring 34, urges the distal end 28 of the actuator portion 26 away from the second clamp body portion 14, and so acts to resiliently bias the first and second flange engagement formations 16, 18 towards one another. Cooperating formations 36 on each of the first and second and second clamp body portions 12, 14 act to limit the extent to which the first and second flange engagement formations 16, 18 are able to move towards one another and thereby define a desired equilibrium spacing between the first and second flange engagement formations 16, 18, e.g. as shown in FIG. 1.

Meanwhile, movement of the distal end 28, i.e. via the enlarged engagement head 30 defined thereby, towards the second clamp body 14 acts against the aforementioned resilient bias to move the first and second flange engagement formations 16, 18 away from one another.

In addition to the foregoing, the second clamp body portion 14 includes a retention formation 38 which is formed within the second clamp body portion 14, and more particularly takes the form of a recess 40 formed within the second clamp body portion 14.

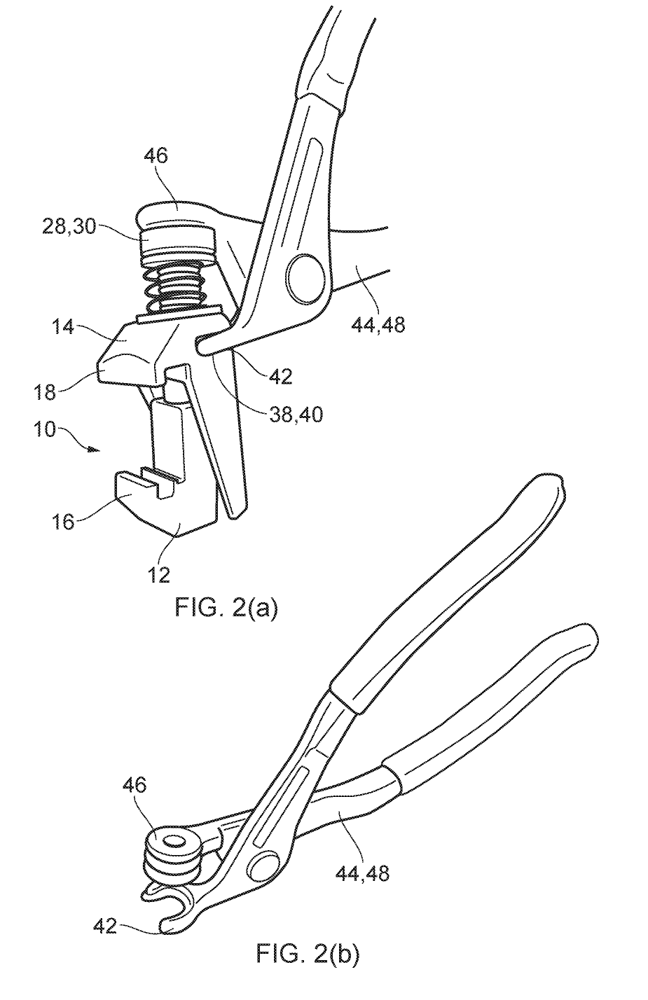

The retention formation 38, i.e. the recess 40, is configured to retain a first jaw 42 of a plier tool 44 and thereby facilitate the application of a force by a second jaw 46 of the plier tool 44 to the distal end 28, i.e. the enlarged engagement head 30, of the actuator portion 26, e.g. as shown in FIG. 2(a).

A preferred type of plier tool 44 for use with the first clamp 10 is a so-called pair of Cleco® pliers 48, as shown on their own in FIG. 2(b), which are specifically adapted for use with proprietary Cleco® fasteners.

In order to securely hold first and second fluid conduits 50, 52, which have respective flanges 54, in fluid-tight engagement with one another, the first clamp 10 is preferably used in accordance with the following steps.

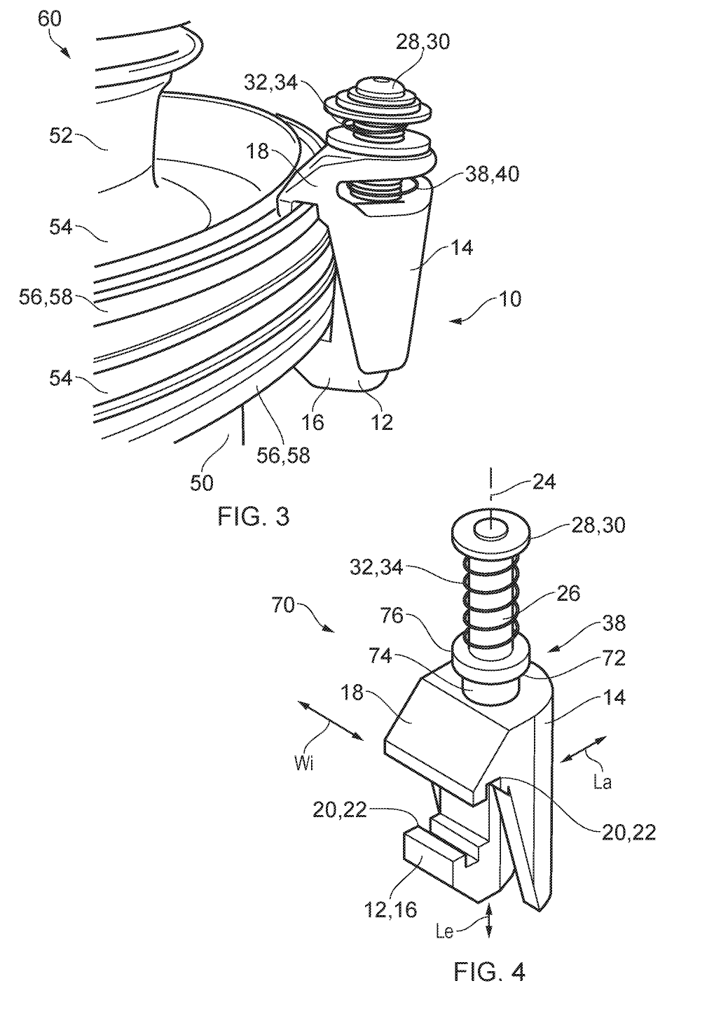

Firstly, the first and second fluid conduits 50, 52 are arranged in engagement with one another, e.g. as shown in FIG. 3.

A plier tool 44, such as a pair of Cleco® pliers 48, is then engaged with the first clamp 10, e.g. in the manner shown in FIG. 2(a) in which a first jaw 42 of the pliers 48 is inserted into the retention formation 38, i.e. the recess 40, formed within the second clamp body 14 and a second jaw 46 is engaged with the enlarged engagement head 30 at the distal end 28 of the actuator portion 26.

The pliers 48 are then used to move the first and second flange engagement formations 16, 18 away from one another by driving the enlarged engagement head 30 towards the second clamp body portion 14 to compress the compression spring 34 and thereby temporarily overcome the resilient bias provided by the said compression spring 34, i.e. the biasing member 32.

The increased spacing from one another of the first and second flange engagement formations 16, 18 assists an operative in arranging the first and second flange engagement formations 16, 18 in communication with, i.e. in close proximity to, the respective flanges 54 of the first and second fluid conduits 50, 52.

Thereafter, the pliers 48 are released and removed to permit the resilient biasing provided by the compression spring 34 to move the first and second flange engagement formations 16, 18 towards one another to secure the respective flanges 54 of the first and second fluid conduits 50, 52 together and thereby hold the first and second fluid conduits 50, 52 in fluid-tight engagement with one another, as shown in FIG. 3.

Each respective flange 54 includes a flange formation 56, which in the example shown takes the form of a circumferential lip 58 (although other flange formations may also be used), that cooperates with the recess formation 20, i.e. slot 22, included in each of the first and second flange engagement formations 16, 18 to inhibit radial movement of the first clamp 10 away from each of the first and second fluid conduits 50, 52.

The foregoing steps result in a fluid conduit assembly 60, e.g. as shown in FIG. 3, which comprises first and second fluid conduits 50, 52, each of which has a respective flange 54, and in which the said respective flanges 54 are secured together by the first clamp 10 so as to hold the first and second fluid conduits 50, 52 in fluid-tight engagement with one another.

A clamp according to a second embodiment of the invention is designated generally by reference numeral 70, as shown in FIG. 4.

The second clamp 70 is similar to the first clamp 10 and like features share the same reference numerals. The second clamp 70 does, however, differ from the first clamp 10 in that the second clamp body portion 14 includes a retention formation 38, to retain a first jaw 42 of a plier tool 44, which instead extends beyond the second clamp body portion 14.

More particularly, the retention formation 38 includes a rebate formation 72 behind which, in use, the said first jaw 42 of a plier tool 44 lodges so as to permit the required application of a force by a second jaw 46 of the plier tool 44 to the distal end 28 of the actuator portion 26.

More particularly still in the second clamp 70 shown, the retention formation 38 takes the form of an annular boss 74 which extends from the second clamp body portion 14 and includes an annular collar 76 that defines the rebate formation 72. Other forms of retention formation are also possible however.

The second clamp 70 is used in essentially the same manner as the first clamp 10.

Table of reference numerals

| | |
|---|---|
| 10 | First clamp |
| 12 | First clamp body portion |
| 14 | Second clamp body portion |
| 16 | First flange engagement formation |
| 18 | Second flange engagement formation |
| 20 | Recess formation |
| 22 | Slot |
| 24 | Common axis |
| 26 | Actuator portion |
| 28 | Distal end |
| 30 | Engagement head |
| 32 | Biasing member |
| 34 | Compression spring |
| 36 | Cooperating formations |
| 38 | Retention formation |
| 40 | Recess |
| 42 | First jaw |
| 44 | Plier tool |
| 46 | Second jaw |
| 48 | Cleco ® pliers |
| 50 | First fluid conduit |
| 52 | Second fluid conduit |
| 54 | Flange |
| 56 | Flange formation |
| 58 | Lip |
| 60 | Fluid conduit assembly |
| 70 | Second clamp |
| 72 | Rebate formation |
| 74 | Annular boss |
| 76 | Annular collar |
| Wᵢ | Width-wise direction |
| Lₑ | Lengthwise direction |
| Lₐ | Lateral direction |

We claim:

1. A clamp, for holding first and second fluid conduits in fluid-tight engagement with one another via respective flanges thereof, comprising first and second clamp body portions defining corresponding first and second mutually opposed flange engagement formations, the first clamp body portion being slidably received within the second clamp body portion to restrain linearly movement of the first and second flange engagement formations towards and away from one another, the first and second flange engagement formations being resiliently biased towards one another.

2. The clamp of claim 1 wherein the first clamp body portion includes an actuator portion which extends through and beyond the second clamp body portion, the actuator portion terminating at a distal end and movement of the distal end towards the second clamp body portion acting against the resilient bias to move the first and second flange engagement formations away from one another.

3. The clamp of claim 2 wherein the distal end of the actuator portion defines an enlarged engagement head.

4. The clamp of claim 2 wherein the distal end of the actuator portion defines an enlarged engagement head and the enlarged engagement head retains a biasing member between the distal end of the actuator portion and the second clamp body portion, the biasing member urging the distal end away from the second clamp body portion.

5. The clamp of claim 2 wherein the second clamp body portion includes a retention formation configured to retain a first jaw of a plier tool and thereby facilitate the application of a force by a second jaw of the plier tool to the distal end of the actuator portion.

6. The clamp of claim 2 wherein the second clamp body portion includes a retention formation configured to retain a first jaw of a plier tool and thereby facilitate the application of a force by a second jaw of the plier tool to the distal end of the actuator portion and the retention formation is formed within the second clamp body portion.

7. The clamp of claim 2 wherein the second clamp body portion includes a retention formation configured to retain a first jaw of a plier tool and thereby facilitate the application of a force by a second jaw of the plier tool to the distal end of the actuator portion and the retention formation extends beyond the second clamp body portion.

8. The clamp of claim 2 wherein the second clamp body portion includes a retention formation configured to retain a first jaw of a plier tool and thereby facilitate the application of a force by a second jaw of the plier tool to the distal end of the actuator portion, the retention formation extends beyond the second clamp body portion, and the retention formation includes a rebate formation.

9. The clamp of claim 1, further comprising a fluid conduit assembly having a first and a second fluid conduit, each having a respective flange, in which the flanges are secured together by the clamp so as to hold the first and second fluid conduits in fluid tight engagement with one another.

10. A method of holding first and second fluid conduits in fluid-tight engagement with one another via respective flanges thereof comprising the steps of:
(a) arranging the first and second fluid conduits in engagement with one another;
(b) utilising a plier tool to move first and second flange engagement formations of a clamp according to claim 1 away from another;
(c) arranging the first and second flange engagement formations in communication with the respective flanges of the first and second fluid conduits; and
(d) removing the plier tool to permit resilient biasing of the first and second flange engagement formations towards one another to secure the respective flanges of the first and second fluid conduits together and thereby hold the first and second fluid conduits in fluid-tight engagement with one another.
